(19) United States
(12) Patent Application Publication
(10) Pub. No.: US 2006/0195833 A1
(43) Pub. Date: Aug. 31, 2006

(54) Data-burning method and system thereof based on auto-detection of computer platform

(75) Inventor: Jeffrey Lo, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,415

(22) Filed: Feb. 25, 2005

(51) Int. Cl. G06F 9/44

(52) U.S. Cl. 717/168

(57) ABSTRACT

A data-burning method and system thereof based on auto-detection of computer platform are proposed. The method and system is applicable to a computer platform main unit, wherein the computer platform main unit has a programmable memory unit thereon, so as to burn a set of digital data into the programmable memory unit. The present invention is characterized in that different types of computer platforms can be automatically detected to enable corresponding digital data be burned into the programmable memory unit provided on the computer platform main units. Therefore, burning of an incorrect BIOS programming data code onto the computer platform as a result of human error is prevented, so that reliability and fabrication efficiency of a computer main system circuit board can be improved.

### FIELD OF THE INVENTION

The present invention relates to a computing system technology, and more particularly, to a data-burning method and system thereof based on auto-detection of computer platform, applicable to a computer platform main unit (such as a computer main system circuit board), wherein the computer platform main unit has a programmable memory unit (such as a flash memory unit) thereon, so that a set of digital data such as a set of Basic Input/Output System (BIOS) program data codes can be burned onto the programmable memory unit. The present invention is characterized in that each type of computer platform can be automatically detected to enable corresponding digital data be burned onto the programmable memory unit provided on the computer platform.

### BACKGROUND OF THE INVENTION

Basic Input/Output System (BIOS) is a system input/output control program which is employed by a personal computer platform or a network server, which serves as an interface between an operating system and each of hardware elements and peripheral devices. Therefore, the computer platform can control the hardware elements and the peripheral devices via the operating system, and utilize functions provided by the hardware elements and peripheral devices.

During practical application, BIOS programming data codes are usually written as a set of programming data codes in advance by a programmer according to the specification of the computer platform. Then, during actual fabrication of a computer platform main unit (for example, a computer main system circuit board), the BIOS programming data code required by the computer platform main unit is downloaded and subsequently burned into a programmable memory such as a flash memory on the computer platform main unit.

Practically speaking, as a number of computer platforms of different types and specifications are simultaneously fabricated by computer manufacturers, different BIOS programming data codes need to be respectively burned onto these computer platforms. Presently, each type-of computer platform is determined manually by an engineer's visual inspection prior to performing a burning process by selecting different BIOS programming data codes required, according to predetermined results, by each type of computer platform.

However, the foregoing method is inherent with significant drawbacks. As computer platforms of various types might have similar appearances, the engineer can not easily distinguish each type of computer platform manually. Thus, an incorrect BIOS programming data code might be mistakenly selected for performing the burning process due to human error. If the incorrect BIOS programming data code is burned onto a computer platform, such computer platform will be unable to operate normally, resulting a defective product.

### SUMMARY OF THE INVENTION

In light of the above prior-art drawbacks, an objective of the present invention is to provide a data-burning method and system thereof based on auto-detection of computer platform, whereby a computer platform can be automatically detected to enable a set of corresponding BIOS programming data codes be burned into a BIOS memory of the computer platform.

In accordance with the above and other objectives, the present invention proposes a data-burning method and system thereof based on auto-detection of computer platform, which is applicable to a computer platform main unit (such as a computer main system circuit board), wherein the computer platform main unit has a programmable memory unit (such as a flash memory unit) thereon, so that a set of digital data such as a set of BIOS programming data codes can be burned into the programmable memory unit.

The data-burning method and system thereof based on auto-detection of computer platform proposed in the present invention is characterized in that each type of computer platform can be automatically detected to enable corresponding digital data be burned into the programmable memory unit provided on the computer platform. Therefore, burning of an incorrect BIOS programming data code into the computer platform main unit due to human error is prevented, so that reliability and fabrication efficiency of the computer host circuit board can be improved.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing basic construction of a data-burning system based on auto-detection of computer platform and an object-oriented component model thereof according to the present invention;

FIG. 2A is a schematic diagram showing a data-burning method based on auto-detection of computer platform according to an embodiment of the present invention; and

FIG. 2B is a schematic diagram showing a data-burning method based on auto-detection of computer platform according to another embodiment of the present invention.

### DETAILED DESCRIPTION OF THE EMBODIMENTS

A data-burning system and method thereof based on auto-detection of computer platform according to the present invention can be more fully understood by reading the following exemplary preferred embodiments.

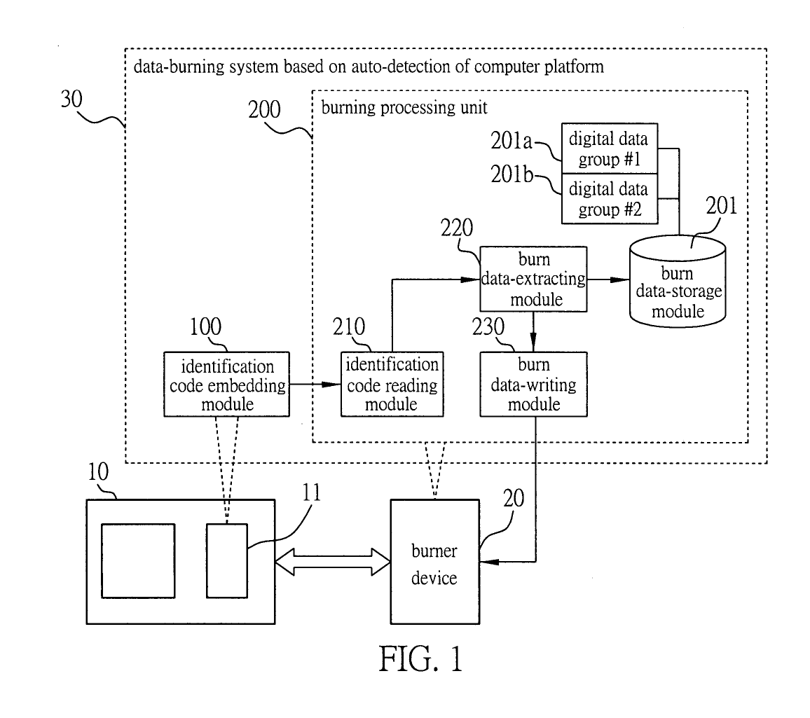

FIG. 1 is a schematic diagram showing basic construction of a data-burning system based on auto-detection of computer platforms (shown as parts included in a dash-lined frame indicated by the reference numeral 30) and an object-oriented component model thereof according to the present invention. As shown in FIG. 1, a data-burning system 30 based on auto-detection of computer platform is practically associated with a burner device 20 and a computer platform main unit 10 (such as a main system circuit board of the computer platform), wherein the computer platform main unit 10 has a programmable memory unit 11 (such as a flash memory unit) thereon, so that a set of digital data such as a set of Basic Input/Output System (BIOS) programming data codes can be burned into the programmable memory unit 11 by the burner device 20. The data-burning system 30 based on auto-detection of computer platform is characterized in that the specific type of the computer platform main unit 10 can be automatically detected to enable a set of corresponding digital data be burned into the programmable memory unit 11 provided on the computer platform.

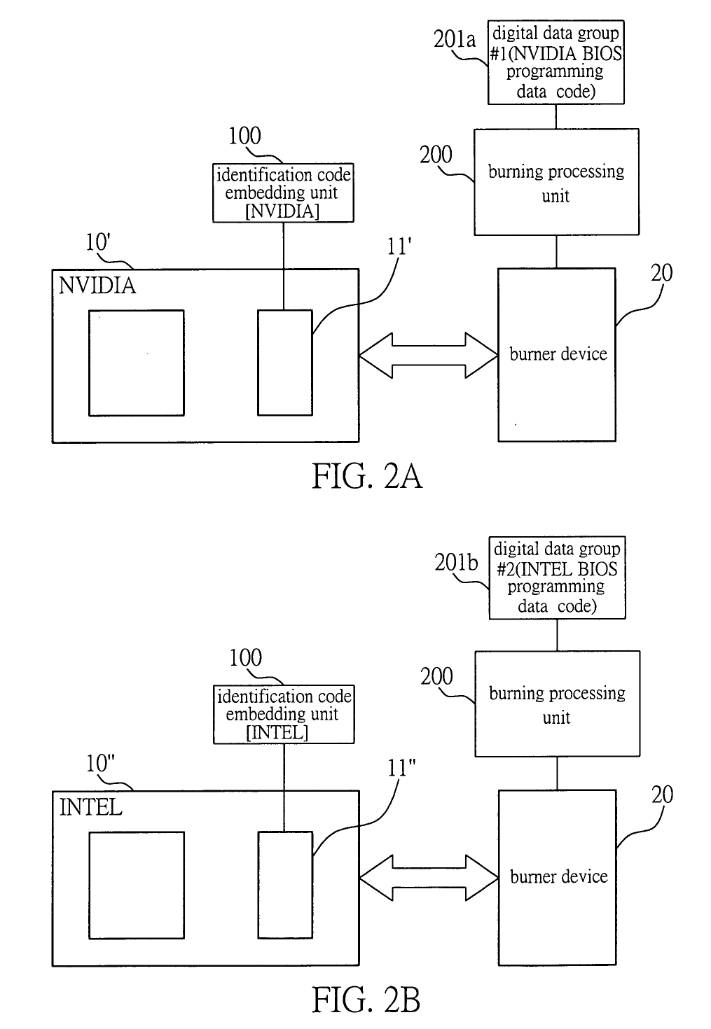

FIG. 2A and FIG. 2B are schematic diagrams showing the data-burning system 30 based on auto-detection of computer platform is applicable to two different computer platform main units, respectively (indicated as reference numerals 10′ and 10″) according to the present invention. Referring to FIG. 2A, a computer platform main unit 10′ is supposedly a computer main system circuit board fabricated by NVIDIA Corporation. The data-burning system 30 can automatically detect the specific type of the computer platform main unit 10′ “NVIDIA” to enable a set of corresponding NVIDIA BIOS programming data codes 201a be burned into a programmable memory unit 11′ provided on the computer platform main unit 10′. Referring to FIG. 2B, a computer platform main unit 10″ is supposedly a computer main system circuit board fabricated by INTEL Corporation. The data-burning system 30 can automatically detect the specific type of the computer platform main unit 10″ “INTEL” to enable a set of corresponding INTEL BIOS programming data codes 201b burned into a programmable memory unit 11″ provided on the computer platform main unit 10″. (Note: In the embodiments shown in FIG. 2A and FIG. 2B, only two types of computer main system circuit boards are used as demonstrative explanation. However, the present invention is also applicable to other types of computer main system circuit boards during practical application.)

Referring to FIG. 1, an object-oriented component model of the data-burning system 30 based on auto-detection of computer platform comprises at least two separate units, including a identification code embedding unit 100 and a burning processing unit 200. The identification code embedding unit 100 is integrated in the host units 10′ and 10″ of various computer platforms. Also, the burning processing unit 200 is integrated in the burner device 20. The internal architecture of the burning processing unit 200 comprises (a) a burn data-storage module 201, (c) a identification code-reading module 210, (d) a burn data-extracting module 220, and (e) a burn data-writing module 230. More specifically, the burning processing unit 200 can be accomplished with a computer program that is integrated in the burner device 20.

The identification code embedding unit 100 is integrated in the computer platform main units 10′ and 10″, so as to embed specific identification codes in the computer platform main units. In other words, the specific identification codes can be burned into the programmable memory units 11′ and 11″ provided on the host units 10′ and 10″. For example, if the computer platform main unit is a computer main system circuit board fabricated by NVIDIA Corporation, the identification code embedding unit 100 can burn a character string such as “NVIDIA” serving as the identification code in a specific address in the programmable memory unit 11′. If the computer platform main unit 10″ is a computer main system circuit board fabricated by INTEL Corporation, the identification code embedding unit 100 can burn a character string such as “INTEL” serving as the identification code in a specific address in the programmable memory unit 11″.

The burn data-storage module 201 serves to store digital data, for example, a set of NVIDIA BIOS programming data codes 201a and a set of INTEL BIOS programming data codes 201b, respectively required by the programmable memory units 11′ and 11″ on the computer platform main units 10′ and 10″. (Note: In the embodiment shown in FIG. 1, only two sets of programming data codes 201a and 201b are used as demonstrative explanation. However, the number of sets of programming data codes stored in the burn data-storage module 201 is unlimited during the practical application.)

When a burning process is performed in the programmable memory units 11′ and 11″ respectively provided on the computer platform main units 10′ and 10″, the identification code-reading module 210 serves to read data of the identification code which is displayed by the identification code embedding unit 100.

The burn data-extracting module 220 serves to extract a set of programming data codes corresponding to the identification code from the burn data-storage module 201 according to the identification code read by the foregoing identification code-reading module 210 and a preset corresponding relationship. For example, if the read identification code is “NVIDIA”, a corresponding NVIDIA BIOS programming data code 201a is extracted from the burn data-storage module 201. Similarly, if the read identification code is “INTEL”, a corresponding INTEL BIOS programming data code 201b is extracted from the burn data-storage module 201.

The burn data-writing module 230 serves to write the programming data code (201a or 201b) extracted from the burn data-storage module 201 by the foregoing burn data-extracting module 220 into the programmable memory unit (11′ or 11″) on the computer platform main unit (10′ or 10″) using the burner device 20. Furthermore, if the programming data code (201a or 201b) extracted from the burn data-storage module 201 is a compressed file, the burn data-writing module 230 will firstly perform a decompression process to the compressed file. Subsequently, the decompressed burn data can be written in the programmable memory unit (11′ or 11″) on the computer platform main unit (10′ or 10″).

During the practical application, the data-burning system 30 based on auto-detection of computer platform is supposedly applied to burn the NVIDIA BIOS programming data code and the INTEL BIOS programming data code into two computer platform main units 10′ and 10″, respectively shown in FIG. 2A and FIG. 2B.

Referring to FIG. 1 and FIG. 2A, when the burner device 20 is connected to the computer platform main unit 10′ shown in FIG. 2A, the data-burning system 30 serves to firstly enable the identification code-reading module 210 to read the identification code “NVIDIA” being previously embedded in the programmable memory unit 11′ on the computer platform main unit 10′. Subsequently, the read identification code “NVIDIA” is transmitted to the burn data-extracting module 220, so that the burn data-extracting module 220 can extract a set of the NVIDIA BIOS programming data code 201a corresponding to the read identification code “NVIDIA” from the burn data-memorizing module 201. Then, the extracted NVIDIA BIOS programming data code 201a is written into the programmable memory unit 11′ by the burn data-writing module 230 via the burner device 20.

Referring to FIG. 1 and FIG. 2B, when the burner device 20 is connected to the computer platform main unit 10″ shown in FIG. 2B, the data-burning system 30 serves to firstly enable the identification code-reading module 210 to read the identification code “INTEL” being previously embedded in the programmable memory unit 11″ on the computer platform main unit 10″. Subsequently, the read identification code “INTEL” is transmitted to the burn data-extracting module 220, so that the burn data-extracting module 220 can extract a set of the INTEL BIOS programming data code 201b corresponding to the read identification code “INTEL” from the burn data-memorizing module 201. Then, the extracted INTEL BIOS programming data code 201a is written into the programmable memory unit 11″ by the burn data-writing module 230 via the burner device 20.

Overall, the present invention proposes a data-burning method and system thereof based on auto-detection of computer platform, applicable to a computer platform main unit, wherein the computer platform main unit has a programmable memory unit thereon, so as to burn a set of digital data onto the programmable memory unit. The present invention is characterized in that different types of computer platforms can be automatically detected to enable corresponding digital data be burned into the programmable memory unit provided on the computer platform main unit. Thus, burning of an incorrect BIOS programming data code into the computer platform main unit as a result of human error is prevented, so that reliability and fabrication efficiency of the computer host circuit board can be improved.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A data-burning method based on auto-detection of computer platform, is applicable to a burner device and a computer platform main unit, wherein the computer platform main unit has a programmable memory unit thereon, so as to provide a data-burning process for the programmable memory unit; the data-burning method based on auto-detection of the computer platforms at least comprising steps of:
embedding a specific identification code in the computer platform main unit;
storing a plurality of sets of digital data to be burned into the computer platform main unit in the burner device;
reading the identification code embedded in the computer platform main unit when performing the burning process in the the computer platform main unit;
extracting a corresponding set of digital data from the plurality of sets of stored digital data based on the read identification code and a preset corresponding relationship; and
writing the extracted digital data into the programmable memory unit.

2. The data-burning method based on auto-detection of computer platform of claim 1, wherein the computer platform main unit is a computer main system circuit board.

3. The data-burning method based on auto-detection of computer platform of claim 1, wherein the programmable memory unit is a flash memory.

4. The data-burning method based on auto-detection of computer platform of claim 1, wherein those sets of digital data include Basic Input/Output System (BIOS) programming data codes.

5. A data-burning system based on auto-detection of computer platform, is applicable to a burner device and a computer platform main unit, wherein i the computer platform main unit has a programmable memory unit thereon, so as to provide a data-burning process for the programmable memory unit; the data-burning system based on auto-detection of computer platforms at least comprising:
a identification code-embedding unit integrated in the computer platform main unit, such that a specific identification code is respectively embedded in the computer platform main unit; and
a burn processing unit integrated in the burner device, and at least comprising:
a burn data-storage module for storing a plurality of sets of digital data to be burned in the computer platform main unit;
a identification code-reading module for reading the identification code displayed by the identification code-embedding module when the computer platform main unit is performing the burning process;
a burn data-extracting module for extracting a corresponding set of digital data from the burn data-storage module according to the identification code read by the identification code-reading module and a preset corresponding relationship; and
a burn data-writing module for writing the digital data extracted by the burn data-extracting module into the programmable memory unit.

6. The data-burning system based on auto-detection of computer platform of claim 5, wherein the computer platform main unit is a computer main system circuit board.

7. The data-burning system based on auto-detection of computer platform of claim 5, wherein the programmable memory unit is a flash memory.

8. The data-burning system based on auto-detection of computer platform of claim 5, wherein those sets of digital data are BIOS programming data codes.
